(19) United States
(12) Patent Application Publication
(10) Pub. No.: US 2013/0322422 A1
(43) Pub. Date: Dec. 5, 2013

(54) TELECOMMUNICATIONS METHODS FOR IMPLEMENTING EARLY TERMINATION OF TRANSMISSION

(71) Applicant: MEDIATEK INC., Hsin-Chu (TW)

(72) Inventors: Pei-Shiun Chung, New Taipei City (TW); Xiu-Sheng Li, Hsinchu City (TW)

(73) Assignee: MEDIATEK INC., Hsin-Chu (TW)

(21) Appl. No.: 13/798,156

(22) Filed: Mar. 13, 2013

Related U.S. Application Data
(60) Provisional application No. 61/653,614, filed on May 31, 2012.

(51) Int. Cl. H04L 1/00

(52) U.S. Cl. CPC H04L 1/0051
USPC 370/342; 370/310

(57) ABSTRACT

An embodiment of the invention provides a telecommunications method performed by a first telecommunications device while communicating with a second telecommunications device. According to the embodiment, the first telecommunications device generates a physical bits block based on an encoded bits block, wherein the physical bits block fits an available physical bits number. Then, the first telecommunications device maps the physical bits block onto a physical channel. Next, the first telecommunications device either performs or not performs early termination for the physical bits block.

### CROSS REFERENCE TO RELATED APPLICATIONS

This application claims the benefit of U.S. provisional application No. 61/653,614, filed on May 31, 2012 and incorporated herein by reference.

### BACKGROUND

1. Technical Field

The invention relates generally to telecommunications, and more particularly, to telecommunications methods for implementing early termination of transmission.

2. Related art

Telecommunications channels are frequently noisy and unreliable. As a result, if a first telecommunications device transmits M bits of data to a second telecommunications device without using any protection, where M is a positive integer, the second telecommunications device may fail to recover some of the M bits correctly.

The two telecommunications devices may use some methods to deal with the aforementioned and other problems. For example, the first telecommunications device may encode the M bits of data into N bits of data that permits error correction, where N is a positive integer greater than M. Then, the first telecommunications device may transmit the N bits of data, rather than only the M bits of data, to the second telecommunications device.

As long as the second telecommunications device has at least P bits of the N bits of data correctly, where P is a positive integer equal to or greater than M and equal to or less than N, the second telecommunications device might be able to successfully decode the M bits of data. This characteristic may allow the two telecommunications devices to have early termination (ET) of transmission whenever the second telecommunications device has acquired enough pieces of a data block and is able to decode the data block. Specifically, if the second telecommunications device determines that it can decode a not yet fully received data block, the second telecommunications device may disregard a remaining part (i.e. a not yet received part) of the data block. This may help the second telecommunications device save some energy and time. In addition, the second telecommunications device may advise the first telecommunications device to not transmit a remaining part (i.e. a not yet transmitted part, which may be smaller than the not yet received part due to time lag) of the data block. This may help the first telecommunications device to save energy and reduce interference to other second telecommunications devices.

To make the implementation of ET of transmission more easily, a new encoding chain is required.

### SUMMARY

An embodiment of the invention provides a telecommunications method performed by a first telecommunications device while communicating with a second telecommunications device. According to the embodiment, the first telecommunications device generates a physical bits block based on an encoded bits block, wherein the physical bits block fits an available physical bits number. Then, the first telecommunications device maps the physical bits block onto a physical channel. Next, the first telecommunications device either performs or not performs early termination for the physical bits block.

Another embodiment of the invention provides a telecommunications method performed by a first telecommunications device while communicating with a second telecommunications device. According to the embodiment, the first telecommunications device first mixes a plurality of transport channels into a mixed transport channel. Then, the first telecommunications device generates an encoded bits block based on a source bits block of the mixed transport channel. Afterwards, the first telecommunications device generates a physical bits block based on the encoded bits block, wherein the physical bits block fits an available physical bits number. Then, the first telecommunications device maps the physical bits block onto a physical channel. Next, the first telecommunications device either performs or not performs early termination for the physical bits block. Then, the first telecommunications device controls a transmission power for the encoded bits block based on a used transport format.

Other features of the present invention will be apparent from the accompanying drawings and from the detailed description which follows.

### BRIEF DESCRIPTION OF THE DRAWINGS

The invention is fully illustrated by the subsequent detailed description and the accompanying drawings, in which like references indicate similar elements.

FIG. 1 shows a simplified flowchart of an encoding chain according to an embodiment of the invention.

FIG. 2 shows two exemplary mechanisms for mixing transport channels.

FIG. 3 shows three examples illustrating step 130 of FIG. 1.

### DETAILED DESCRIPTION

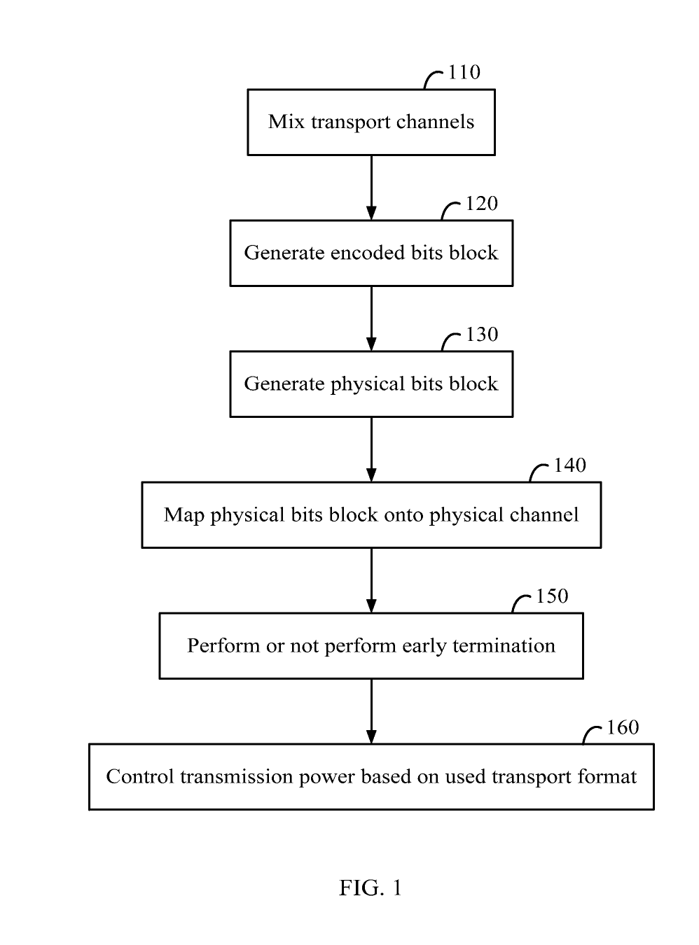

FIG. 1 shows a simplified flowchart of an encoding chain according to an embodiment of the invention. While communicating with a second telecommunications device, a first telecommunications device may adopt this encoding chain to facilitate ET of transmission. One of these two telecommunications devices may be a base station (BS) or a Node B while the other may be a mobile station (MS) or a piece of user equipment (UE). For example, these two telecommunications devices may be wideband code division multiple access (WCDMA) telecommunications devices.

The first telecommunications device may perform the steps of FIG. 1 at different rates. For example, the first telecommunications device may perform steps 110, 120, and 130 transmission time interval (TTI) by TTI, and may perform step 150 slot by slot. Each TTI may include an integer number (e.g. one or two) of frames, each frame may include 15 slots, and each slot may include 2,560 chips of data.

First, at step 110, the first telecommunications device mixes a plurality of transport channels (TrCHs) into one mixed TrCH. This step is optional, and when included, it may make the encoding chain simpler. This step may also make it more easily for the second telecommunications device to decode.

For example, there are four TrCHs for a voice phone call. Three of them are used by dedicated traffic channels (DTCH) for speech information and one of them by dedicated control channel (DCCH) for control messages. Different combination of these three DTCHs stands for different speech packet type. There are three speech information packet type, including mute (0 bit, which is the summation bit number of these three DTCHs), silence indication descriptor (SID, 39 bits), and speech (244 bits). The TTI of the DTCHs is 20 ms long and DTCHs appear in every TTI. On the other hand, the DCCH has only one format of 148 bits. The TTI of the DCCH is 40 ms long and DCCH does not appear in every TTI.

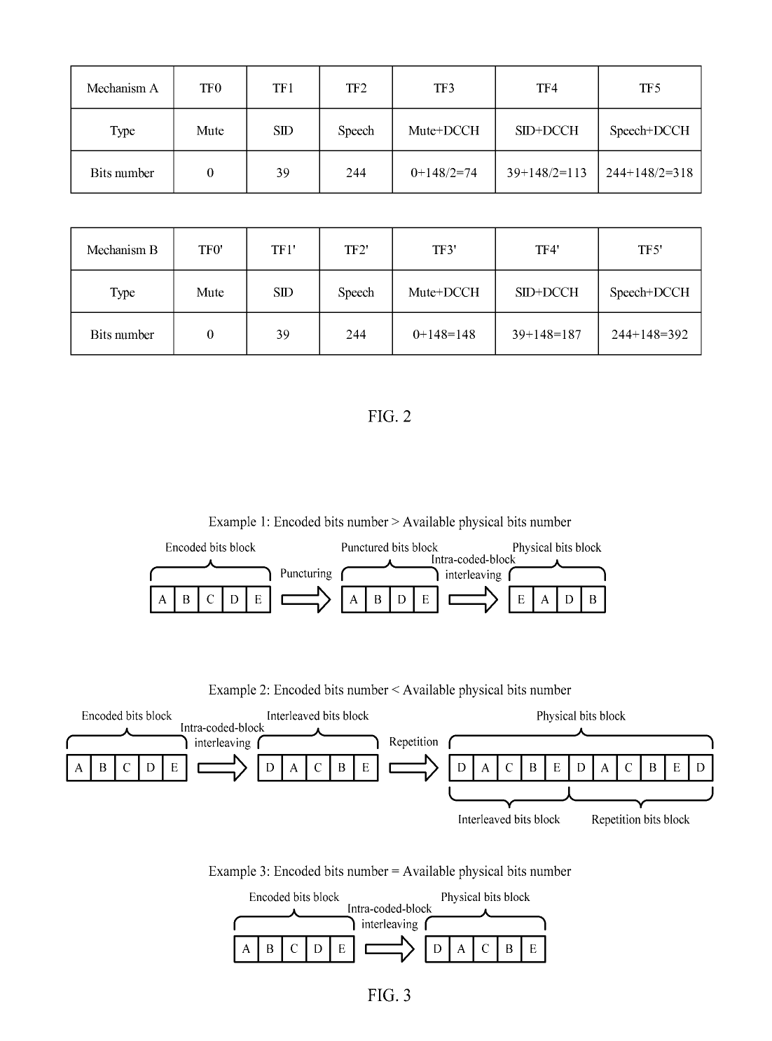

FIG. 2 shows two exemplary mechanisms for mixing DTCHs and DCCH into a single mixed TrCH. In mechanism A, each DCCH is partitioned into two halves, each of which is transmitted within 20 ms. A half DCCH, if there is a DCCH, and DTCHs are then mixed into one TrCH. Mechanism A may result in one of six different transport formats (TF0˜TF5) with different bits numbers. The bits number of a TF is equal to the number of source bits per TTI, and the source bits within each TTI may be referred to as a source bits block. In mechanism B, each DCCH is transmitted twice, each of the two transmissions takes 20 ms. A complete DCCH, if there is a complete DCCH, and DTCHs are then mixed into one TrCH. Mechanism B may also result in one of six different transport formats (TF0′˜TF5′) with different bits numbers.

Next, please refer to FIG. 1 again, at step 120, the first telecommunications device generates an encoded bits block based on a source bits block of the mixed transport channel through, e.g. adding a cyclic redundancy check (CRC) segment and then performing channel encoding. If the CRC segment is added, the CRC segment may later help the second telecommunications device verify whether it has decoded the encoded bits block correctly. The first telecommunications device may adopt any suitable scheme for channel encoding, such as convolutional encoding or turbo encoding.

Then, at step 130, the first telecommunications device generates a physical bits block based the encoded bits block. This step may be referred to as rate matching and interleaving, and may ensure that the physical bits block fits an available physical bits number. In other words, this step generates a physical bits block having a physical bits number equal to the available physical bits number, which may have a fixed value. This step may make the physical channels be used more efficiently, because no bit space is left empty.

FIG. 3 shows three examples illustrating step 130. In the figure, each rectangle encompassing a capital letter represents a data piece. In the first example, an encoded bits number of the encoded bits block (which is 5 data pieces long) is greater than the available physical bits number (which only allows 4 data pieces). The first telecommunications device first punctures the encoded bits block into a punctured bits block by discarding some bits, such as data piece C. Then, the first telecommunications device interleaves the punctured bits block into the physical bits block. The second telecommunications device may later recover the discarded bits through error correction.

In the second example, an encoded bits number of the encoded bits block (which is 5 data pieces long) is less than the available physical bits number (which allows 11 data pieces). The first telecommunications device first interleaves the encoded bits block into an interleaved bits block. Then, because the physical bits block may accommodate 6 more data pieces, there is room for repetition. As a result, the first telecommunications device repeats the interleaved bits block to generate the physical bits block. To help the second telecommunications device acquire a complete copy of the encoded bits block as earlier as possible, the first telecommunications device may let the physical bits block include the interleaved bits block followed by a repetition bits block generated based on the interleaved bits block. In other words, the interleaved bits block may be transmitted earlier than the repetition bits block. The repetition bits block needs not be a rigid repetition of the interleaved bits block; the repetition bits block may contain data pieces of the interleaved bits block in any form and any order.

In the third example, an encoded bits number of the encoded bits block (which is 5 data pieces long) is equal to the available physical bits number (which also allows 5 data pieces). The first telecommunications device directly interleaves the encoded bits block into the physical bits block.

Please refer to FIG. 1 again. At step 140, the first telecommunications device maps the physical bits block onto a physical channel. For example, the first telecommunications device may perform modulation, spreading, etc., at step 140. The first telecommunications device may follow existing specifications at this step.

Then, at step 150, the first telecommunications device either performs or not performs ET for the physical bits block. Specifically, if the first telecommunications device decides to perform ET, it refrains from transmitting a remaining part of the physical bits block to the second telecommunications device. In making the decision, the first telecommunications device may monitor ET indicators (ETIs) received from the second telecommunications device. Each ETI may indicate whether the second telecommunications device advises or not advises ET of transmission. For example, a positive ETI may indicate that the second telecommunications device advises ET of transmission, while a negative ETI may indicate that the second telecommunications device does not advise ET of transmission. The first telecommunications device needs not follow the second telecommunications device's advice rigidly, and may make a decision based on not only the ETIs but also other relevant information.

Besides the physical bits block for speech information and higher layer control information, some other control information (e.g., transmit power control command, pilot field) is also transmitted in physical channel. When ET is performed, the first telecommunications device stops transmitting a remaining part of the physical bits block. The first telecommunications device may also stop the transmission of the physical channel control information or not, depending on the system performance influence.

While receiving the physical bits block, the second telecommunications device may have several successive decoding attempts. After each of the decoding attempt, the second telecommunications device may send an ETI to the first telecommunications device. Some telecommunications specifications may allow the second telecommunications device to transmit a transmit power control (TPC) symbol to the first telecommunications device in every slot in order to control the transmission power of the first telecommunications device. The second telecommunications device may reduce the rate of TPC symbols in order to make room for ETIs. In other words, the second telecommunications device may transmit some ETIs to the first telecommunications device in place of some TPC symbols. For examples, if the second telecommunications device has decoding attempts after receiving slots with even slot indexes, it may transmit TPC symbols to the first telecommunications device in slots with odd slot indexes, and transmit ETIs to the first telecommunications device in slots with even slot indexes.

At step 160, the first telecommunications device controls its transmission power based on the used TF. For example, the first telecommunications device may make the transmission power positively correlated with a bits number of the TF. In other words, the greater the bits number, the higher the transmission power may be. This is because the lesser the bits number, the more repetition there may be. With more repetition, the first telecommunications device needs not to use a relatively higher transmission power to ensure proper reception of the second telecommunications device. Using mechanism A of FIG. 2 as an example, the transmission power for TF2 may be equal to or greater than the transmission power for TF1, and the transmission power for TF1 may be equal to or greater than the transmission power for TF0.

As mentioned above, proper performance of ET of transmission may help the first telecommunications device and the second telecommunications device to save energy and time. This is a great advantage, especially when at least one of the two devices is a portable device powered by a battery. In addition, proper performance of ET of transmission may help reduce interference within the telecommunications system that the first and second telecommunications devices belong to. This may help the telecommunications system to accommodate more telecommunications devices.

In the foregoing detailed description, the invention has been described with reference to specific exemplary embodiments thereof. It will be evident that various modifications may be made thereto without departing from the spirit and scope of the invention as set forth in the following claims. The detailed description and drawings are, accordingly, to be regarded in an illustrative sense rather than a restrictive sense.

What is claimed is:

1. A telecommunications method performed by a first telecommunications device while communicating with a second telecommunications device, the method comprising:
generating a physical bits block based on an encoded bits block, wherein the physical bits block fits an available physical bits number;
mapping the physical bits block onto a physical channel; and
performing or not performing early termination for the physical bits block.

2. The telecommunications method of claim 1, wherein the step of generating the physical bits block based on the encoded bits block comprises:
if an encoded bits number of the encoded bits block is greater than the available physical bits number, puncturing the encoded bits block to generate a punctured bits block and then interleaving the punctured bits block to generate the physical bits block.

3. The telecommunications method of claim 1, wherein the step of generating the physical bits block based on the encoded bits block comprises:
if an encoded bits number of the encoded bits block is less than the available physical bits number, interleaving the encoded bits block to generate an interleaved bits block and then repeating the interleaved bits block to generate the physical bits block.

4. The telecommunications method of claim 3, wherein the physical bits block comprises the interleaved bits block followed by a repetition bits block generated based on the interleaved bits block.

5. The telecommunications method of claim 1, wherein the step of generating the physical bits block based on the encoded bits block comprises:
if an encoded bits number of the encoded bits block is equal to the available physical bits number, interleaving the encoded bits block to generate the physical bits block.

6. The telecommunications method of claim 1, wherein the step of performing or not performing early termination for the physical bits block comprises:
performing or not performing early termination for the physical bits block based on early termination indicators received from the second telecommunications device.

7. The telecommunications method of claim 6, wherein the second telecommunications device transmits each of the early termination indicators to the first telecommunications device in place of a transmit power control (TPC) symbol.

8. The telecommunications method of claim 1, further comprising:
mixing a plurality of transport channels into a mixed transport channel;
generating the encoded bits block based on a source bits block of the mixed transport channel through adding a cyclic redundancy check (CRC) segment and then performing channel encoding.

9. The telecommunications method of claim 1, further comprising:
controlling a transmission power for the encoded bits block based on a used transport format.

10. The telecommunications method of claim 9, wherein the step of controlling the transmission power for the encoded bits block based on the used transport format comprises:
making the transmission power positively correlated with a bits number of the used transport format.

11. The telecommunications method of claim 1, wherein the first telecommunications device and the second telecommunications device are wideband code division multiple access (WCDMA) telecommunications devices.

12. A telecommunications method performed by a first telecommunications device while communicating with a second telecommunications device, the method comprising:
mixing a plurality of transport channels into a mixed transport channel;
generating an encoded bits block based on a source bits block of the mixed transport channel;
generating a physical bits block based on the encoded bits block, wherein the physical bits block fits an available physical bits number;
mapping the physical bits block onto a physical channel;
performing or not performing early termination for the physical bits block; and
controlling a transmission power for the encoded bits block based on a used transport format.

13. The telecommunications method of claim 12, wherein the step of generating the physical bits block based on the encoded bits block comprises:
if an encoded bits number of the encoded bits block is greater than the available physical bits number, puncturing the encoded bits block to generate a punctured bits block and then interleaving the punctured bits block to generate the physical bits block.

14. The telecommunications method of claim 12, wherein the step of generating the physical bits block based on the encoded bits block comprises:
if an encoded bits number of the encoded bits block is less than the available physical bits number, interleaving the encoded bits block to generate an interleaved bits block and then repeating the interleaved bits block to generate the physical bits block.

15. The telecommunications method of claim 14, wherein the physical bits block comprises the interleaved bits block followed by a repetition bits block generated based on the interleaved bits block.

16. The telecommunications method of claim 12, wherein the step of generating the physical bits block based on the encoded bits block comprises:
if an encoded bits number of the encoded bits block is equal to the available physical bits number, interleaving the encoded bits block to generate the physical bits block.

17. The telecommunications method of claim 12, wherein the step of performing or not
performing early termination for the physical bits block comprises:
performing or not performing early termination for the physical bits block based on early termination indicators received from the second telecommunications device.

18. The telecommunications method of claim 17, wherein the second telecommunications device transmits each of the early termination indicators to the first telecommunications device in place of a transmit power control (TPC) symbol.

19. The telecommunications method of claim 12, wherein the step of controlling the transmission power for the encoded bits block based on the used transport format comprises:
making the transmission power positively correlated with a bits number of the used transport format.

20. The telecommunications method of claim 12, wherein the first telecommunications device and the second telecommunications device are wideband code division multiple access (WCDMA) telecommunications devices.
